(19) United States
(12) Patent Application Publication
(10) Pub. No.: US 2004/0098568 A1
(43) Pub. Date: May 20, 2004

(54) Processor having a unified register file with multipurpose registers for storing address and data register values, and associated register mapping method

(76) Inventor: Hung T. Nguyen, Plano, TX (US)

Correspondence Address: LSI LOGIC CORPORATION, 1621 BARBER LANE, MS: D-106 LEGAL, MILPITAS, CA, 95035, US

(21) Appl. No.: 10/299,532

(22) Filed: Nov. 18, 2002

(51) Int. Cl. G06F 9/44

(52) U.S. Cl. 712/225

(57) ABSTRACT

A processor is disclosed including a register file having multiple registers, wherein a portion of the registers are used to store both address register values and data register values. In one embodiment, the processor includes the register file and an instruction decoder. The instruction decoder decodes instructions including an operation code (i.e., opcode) and specifying a register. The instruction decoder maps the register specified by the instruction to a corresponding register of the register file dependent upon the opcode. A method is described for mapping a register specified by an instruction to a corresponding register of a register file. In one embodiment of the method, if an opcode of the instruction specifies an address operation is to be performed, a bank value is appended to a value in the instruction uniquely identifying the specified register, thereby forming a value uniquely identifying the corresponding register of the register file.

### FIELD OF THE INVENTION

This invention relates generally to data processing, and, more particularly, to processors configured to execute software program instructions.

### BACKGROUND OF THE INVENTION

A typical processor inputs (i.e., fetches or receives) instructions from an external memory, and executes the instructions. In general, instruction execution involves an address operation and/or a data operation, wherein the address operation produces an address value (i.e., an address of a memory location in a memory), and the data operation produces a data value.

Most instructions specify operations to be performed using one or more operands. An operand may be specified using one of several different types of addressing modes. In a register indirect with index register addressing mode, the contents of two registers (i.e., two address values) are added together to form an address of a memory location in the external memory, and the operand (i.e., a data value) is obtained from the memory location using the address. Some types of processors (e.g., digital signal processors) have two different register files—an address register file with address registers for storing address values, and a data register file with data registers for storing data values.

For example, known processors are configured to execute add instructions of the form “add Ax,Ny,” where Ax specifies an address register x of an address register file, and Ny specifies an index register y of the address register file. During execution of the add instruction, the processor adds an index value stored in the Ny index register to a base address value stored in an Ax register, and stores the address result in the Ax register. Following execution of the add instructions, the Ax register contains an address of a memory location in a memory (e.g., in an external memory coupled to the processor). The above described add instruction performs an address operation.

Known processors are also configured to execute load instructions of the form “Id Rx,Ay,Nz,” where Rx specifies a register x of a general purpose register file (i.e., a data register file), Ay specifies an address register y of an address register file, and Nz specifies an index register z of the address register file. During execution of the load instruction, the processor forms an address of a memory location by adding an index value stored in the Nz register to a base address value stored in the Ay register, obtains the contents of the memory location using the address, and stores the contents of the memory location in the Rx register. The load instruction involves both an address operation (the forming of the address of the memory location by adding the index value to the base address value) and a data operation (the storing of the contents of the memory location in the Rx register).

In a processor having separate address and data register files, the address register file is typically sized to hold a predetermined number of address values (e.g., base address values and index values). Often times all of the registers of the address register file are not used. As the address register file is used only to store address values, the unused registers of the address register file cannot be used to store data values. Similarly, the data register file is used only to store data values, and unused registers of the data register file cannot be used to store address values. It would therefore be beneficial to have a processor in which unused registers of a register file could be used to store address register values or data register values.

### SUMMARY OF THE INVENTION

A processor is disclosed including a register file having multiple registers, wherein a portion of the registers are used to store both address register values and data register values. For example, an architecture of the processor may specify multiple address registers for storing the address register values, and multiple data registers (e.g., general purpose registers) for storing the data register values. In this situation, the address registers and the data registers are mapped to the same portion of the registers of the register file.

In one embodiment, the processor includes the register file and an instruction decoder. The instruction decoder is configured to decode instructions, wherein each instruction includes an operation code (i.e., opcode) and specifies a register. The instruction decoder maps the register specified by the instruction to a corresponding register of the register file dependent upon the opcode.

For example, the registers of the register file may be arranged to form multiple banks, and the instruction may include a value identifying the register specified by the instruction. In the event the opcode specifies an address operation is to be performed, the instruction decoder may append a bank value to the value identifying the register specified by the instruction, thereby forming a value uniquely identifying the corresponding register of the register file. In this situation, the instruction decoder maps the register specified by the instruction to a register in a corresponding bank of the register file dependent upon the opcode.

A method is described for mapping a register specified by an instruction to a corresponding register of a register file. In one embodiment of the method, if an opcode of the instruction specifies an address operation is to be performed, a bank value is appended to a value in the instruction uniquely identifying the specified register, thereby forming a value uniquely identifying the corresponding register of the register file.

### BRIEF DESCRIPTION OF THE DRAWINGS

The invention may be understood by reference to the following description taken in conjunction with the accompanying drawings, in which like reference numerals identify similar elements, and in which:

FIG. 1 is a diagram of one embodiment of a data processing system including a system on a chip (SOC) having a processor core coupled to a memory system;

FIG. 2 is a diagram of one embodiment of the processor core of FIG. 1, wherein the processor core includes a unified register file and instruction issue logic;

FIG. 3 is a diagram illustrating an instruction execution pipeline implemented within the processor core of FIG. 2;

FIG. 4 is a diagram of one embodiment of the unified register file of FIG. 2; and

FIG. 5 is a diagram of one embodiment of the instruction issue logic of FIG. 2.

### DETAILED DESCRIPTION OF THE PREFERRED EMBODIMENTS

In the following disclosure, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise. Certain terms are used throughout the following description and claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical or communicative connection. Thus, if a first device couples to a second device, that connection may be through a direct connection, or through an indirect connection via other devices and connections.

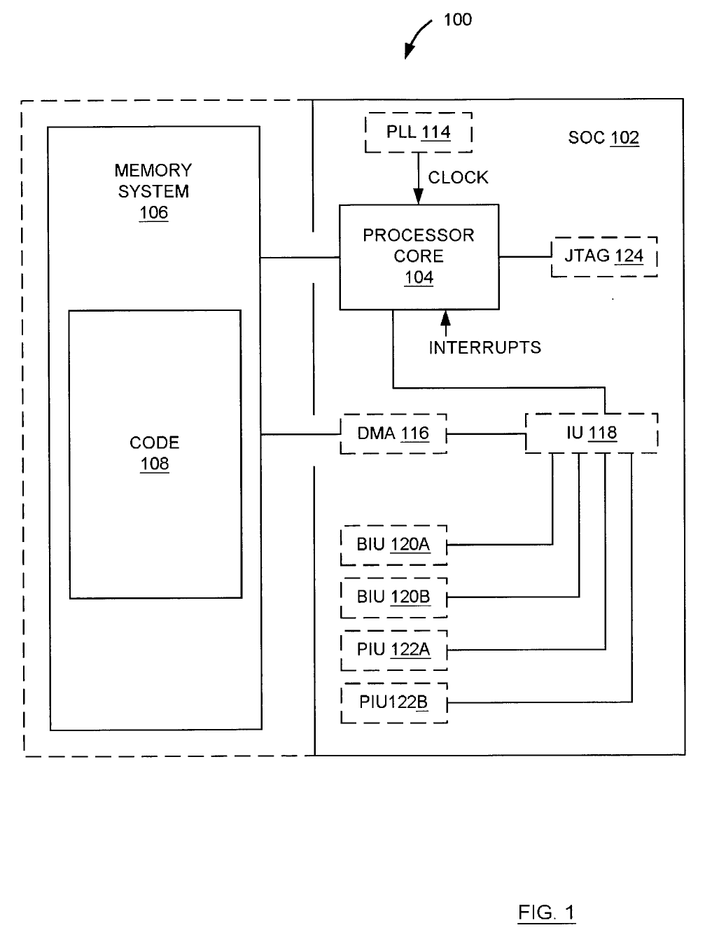

FIG. 1 is a diagram of one embodiment of a data processing system 100 including a chip (SOC) 102 having a processor core 104 coupled to a memory system 106. The processor core 104 executes instructions of a predefined instruction set. As indicated in FIG. 1, the processor core 104 receives a CLOCK signal and executes instructions dependent upon the CLOCK signal.

The processor core 104 is both a “processor” and a “core.” The term “core” describes the fact that the processor core 104 is a functional block or unit of the SOC 102. It is now possible for integrated circuit designers to take highly complex functional units or blocks, such as processors, and integrate them into an integrated circuit much like other less complex building blocks. As indicated in FIG. 1, in addition to the processor core 104, the SOC 102 may include a phase-locked loop (PLL) circuit 114 that generates the CLOCK signal. The SOC 102 may also include a direct memory access (DMA) circuit 116 for accessing the memory system 106 substantially independent of the processor core 104. The SOC 102 may also include bus interface units (BIUs) 120A and 120B for coupling to external buses, and/or peripheral interface units (PIUs) 122A and 122B for coupling to external peripheral devices. An interface unit (IU) 118 may form an interface between the bus interfaces units (BIUs) 120A and 120B and/or the peripheral interface units (PIUs) 122A and 122B, the processor core 104, and the DMA circuit 116. The SOC 102 may also include a JTAG (Joint Test Action Group) circuit 124 including an IEEE Standard 1169.1 compatible boundary scan access port for circuit-level testing of the processor core 104. The processor core 104 may also receive and respond to external interrupt signals (i.e., interrupts) as indicated in FIG. 1.

In general, the memory system 106 stores data, wherein the term “data” is understood to include instructions. In the embodiment of FIG. 1, the memory system 106 stores a software program (i.e., “code”) 108 including instructions from the instruction set. The processor core 104 fetches instructions of the code 108 from the memory system 106, and executes the instructions.

In the embodiment of FIG. 1, the instruction set includes instructions involving address and/or data operations as described above, wherein an address operation produces an address value (i.e., an address of a memory location in the memory system 106), and a data operation produces a data value. The instruction set also includes instructions specifying operands via the register indirect with index register addressing mode, wherein the contents of two registers are added together to form an address of a memory location in the memory system 106, and the operand is obtained from the memory location using the address.

In the embodiment of FIG. 1, different operation codes (i.e., opcodes) are assigned to instructions producing address results and data results. For example, the add instruction “add Ax,Ny” described above produces an address result (i.e., an address of a memory location in the memory system 106) stored in an address register Ax. An opcode of the add instruction “add Ax,Ny” differs from an opcode of, for example, an add instruction “add Rx,—” wherein ‘—’ specifies an operand and the add instruction “add Rx,—” produces a data result stored in a “data” register Rx (e.g., a general purpose register Rx).

In the embodiment of FIG. 1, the processor core 104 implements a load-store architecture. That is, the instruction set includes load instructions used to transfer data from the memory system 106 to registers of the processor core 104, and store instructions used to transfer data from the registers of the processor core 104 to the memory system 106. Instructions other than the load and store instructions specify register operands, and register-to-register operations. In this manner, the register-to-register operations are decoupled from accesses to the memory system 106.

The memory system 106 may include, for example, volatile memory structures (e.g., dynamic random access memory structures, static random access memory structures, etc.) and/or non-volatile memory structures (read only memory structures, electrically erasable programmable read only memory structures, flash memory structures, etc.).

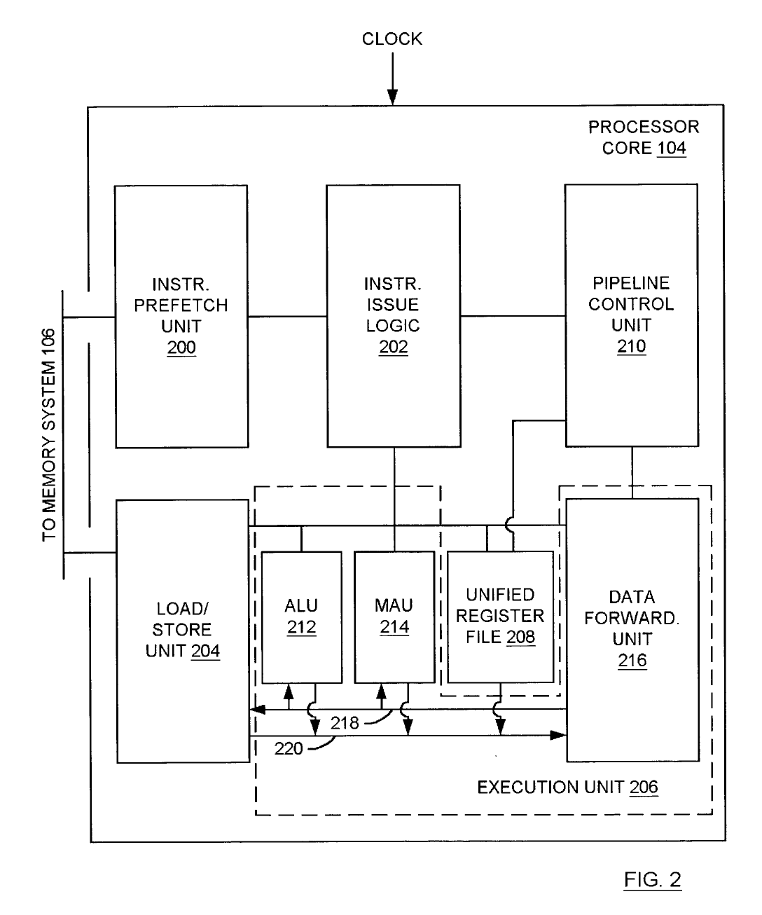

FIG. 2 is a diagram of one embodiment of the processor core 104 of FIG. 1. In the embodiment of FIG. 2, the processor core 104 includes an instruction prefetch unit 200, instruction issue logic 202, a load/store unit 204, an execution unit 206, a unified register file 208, and a pipeline control unit 210. In the embodiment of FIG. 2, the processor core 104 is a pipelined superscalar processor core. That is, the processor core 104 implements an instruction execution pipeline including multiple pipeline stages, concurrently executes multiple instructions in different pipeline stages, and is also capable of concurrently executing multiple instructions in the same pipeline stage.

In general, the instruction prefetch unit 200 fetches instructions from the memory system 106 of FIG. 1, and provides the fetched instructions to the instruction issue logic 202. In one embodiment, the instruction prefetch unit 200 is capable of fetching up to 8 instructions at a time from the memory system 106, partially decodes the instructions, and stores the partially decoded instructions in an instruction cache within the instruction prefetch unit 200.

The instruction issue logic 202 decodes the instructions and translates the opcode to a native opcode, then stores the decoded instructions in an instruction queue 506 (as described below). The load/store unit 204 is used to transfer data between the processor core 104 and the memory system 106 as described above. In the embodiment of FIG. 2, the load/store unit 204 includes 2 independent load/store units.

The execution unit 206 is used to perform operations specified by instructions (and corresponding decoded instructions). In the embodiment of FIG. 2, the execution unit 206 includes an arithmetic logic unit (ALU) 212, a multiply-accumulate unit (MAU) 214, and a data forwarding unit (DFU) 216. The ALU 212 includes 2 independent ALUs, and the MAU 214 includes 2 independent MAUs. The ALU 212 and the MAU 214 receive operands from the instructions issue logic 202, the unified register file 208, and/or the DFU 216. The DFU 216 provides needed operands to the ALU 212 and the MAU 214 via source buses 218. Results produced by the ALU 212 and the MAU 214 are provided to the DFU 216 via destination buses 220.

The unified register file 208 includes multiple registers of the processor core 104, and is described in more detail below. In general, the pipeline control unit 210 controls the instruction execution pipeline described in more detail below.

In one embodiment, the instruction issue logic 202 is capable of receiving (or retrieving) n partially decoded instructions (n>1) from the instruction cache within the instruction prefetch unit 200 of FIG. 2, and decoding the n partially decoded instructions, during a single cycle of the CLOCK signal. The instruction issue logic 202 then issues the n instructions as appropriate.

In one embodiment, the instruction issue logic 202 decodes instructions and determines what resources within the execution unit 206 are required to execute the instructions (e.g., the ALU 212, the MAU 214, etc.). The instruction issue logic 202 also determines an extent to which the instructions depend upon one another, and queues the instructions for execution by the appropriate resources of the execution unit 206.

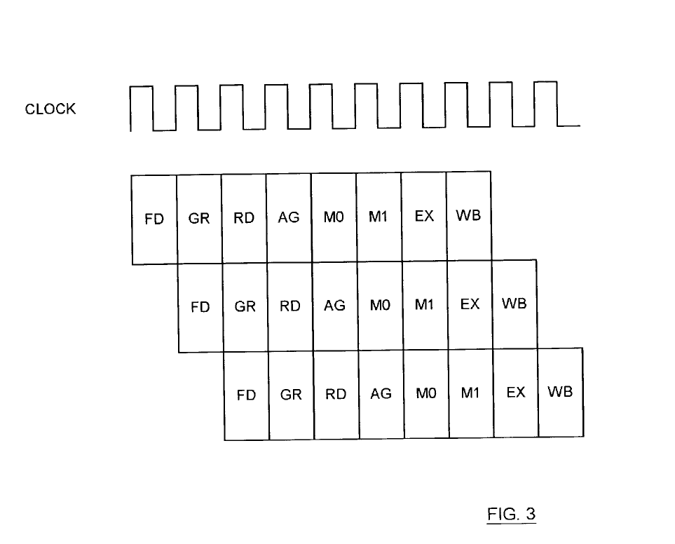

FIG. 3 is a diagram illustrating the instruction execution pipeline implemented within the processor core 104 of FIG. 2. The instruction execution pipeline (pipeline) allows overlapped execution of multiple instructions. In the embodiment of FIG. 3, the pipeline includes 8 stages: a fetch/decode (FD) stage, a grouping (GR) stage, an operand read (RD) stage, an address generation (AG) stage, a memory access 0 (M0) stage, a memory access 1 (M1) stage, an execution (EX) stage, and a write back (WB) stage. As indicated in FIG. 3, operations in each of the 8 pipeline stages are completed during a single cycle of the CLOCK signal.

Referring to FIGS. 2 and 3, the instruction fetch unit 200 fetches several instructions (e.g., up to 8 instructions) from the memory system 106 of FIG. 1 during the fetch/decode (FD) pipeline stage, partially decodes and aligns the instructions, and provides the partially decoded instructions to the instruction issue logic 202. The instruction issue logic 202 fully decodes the instructions and stores the fully decoded instructions in an instruction queue (described more fully later). The instruction issue logic 202 also translates the opcodes into native opcodes for the processor.

During the grouping (GR) stage, the instruction issue logic 202 checks the multiple decoded instructions for grouping and dependency rules, and passes one or more of the decoded instructions conforming to the grouping and dependency rules on to the read operand (RD) stage as a group. During the read operand (RD) stage, any operand values, and/or values needed for operand address generation, for the group of decoded instructions are obtained from the unified register file 208.

During the address generation (AG) stage, any values needed for operand address generation are provided to the load/store unit 204, and the load/store unit 204 generates internal addresses of any operands located in the memory system 106 of FIG. 1. During the memory address 0 (M0) stage, the load/store unit 204 translates the internal addresses to external memory addresses used within the memory system 106 of FIG. 1.

During the memory address 1 (M1) stage, the load/store unit 204 uses the external memory addresses to obtain any operands located in the memory system 106 of FIG. 1. During the execution (EX) stage, the execution unit 206 uses the operands to perform operations specified by the one or more instructions of the group. During a final portion of the execution (EX) stage, valid results (including qualified results of any conditionally executed instructions) are stored in registers of the unified register file 208.

During the write back (WB) stage, valid results (including qualified results of any conditionally executed instructions) of store instructions, used to store data in the memory system 106 of FIG. 1 as described above, are provided to the load/store unit 204. Such store instructions are typically used to copy values stored in registers of the unified register file 208 to memory locations of the memory system 106.

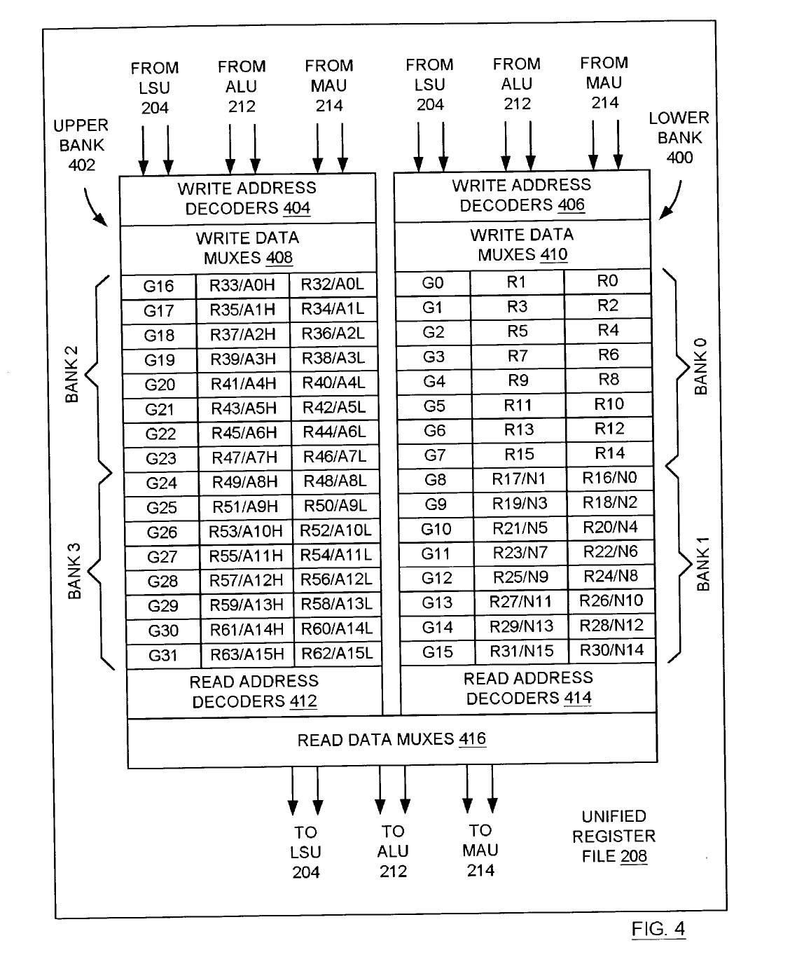

FIG. 4 is a diagram of one embodiment of the unified register file 208 of FIG. 2. As indicated in FIG. 4, the processor core 104 of FIGS. 1 and 2 includes 64 16-bit general purpose registers (GPRs) R0-R63, 16 32-bit address registers A0-A15, and 16 16-bit index registers N0-N15. An architecture of the processor core 104 of FIGS. 1 and 2 specifies the 64 16-bit GPRs R0-R63, the 16 32-bit address registers A0-A15, and the 16 16-bit index registers N0-N15.

In general, the 64 GPRs R0-R63 are used to store data values, and are referred to herein as “data registers.” In contrast, the 16 address registers A0-A15 and the 16 index registers N0-N15 are used to store address values relating to addresses of memory locations in the memory system 106 of FIG. 1. The 16 address registers A0-A15 and the 16 index registers N0-N15 are uniquely identified by corresponding 4-bit values.

In the embodiment of FIG. 4, the unified register file 208 is divided into 4 banks labeled bank 0 through bank 3. To equalize electrical loading within the unified register file 208, bank 0 and bank 1 in combination form a “lower bank” 400 of the unified register file 208, and bank 2 and bank 3 in combination form an “upper bank” 402. In general, the unified register file 208 includes 64 16-bit registers and 32 8-bit registers. Each of the four banks, bank 0 through bank 3, includes 16 16-bit registers and 8 8-bit registers. The 8-bit registers, labeled Gx in FIG. 4, are guard registers for 40-bit data operations carried out in the MAU 214 of FIG. 2.

The 16 16-bit registers in bank 0 are dedicated to general purpose register (GPR) use, and are labeled R0 through R15 in FIG. 4. The 16 16-bit registers in bank 0 are arranged in pairs, and each of the 8-bit guard registers Gx is associated with the corresponding pair of general purpose registers R(2x) and R(2x+1), where 7≧×≧0.

The 16 16-bit registers in bank 1 may be used to store 16-bit GPR (Rx) values or 16-bit index (Nx) values used during address operations, and are labeled R16/N0 through R31/N15 in FIG. 4. The 16 16-bit registers in bank 1 are arranged in pairs, and each of the 8-bit guard registers Gx is associated with the corresponding pair of general purpose registers R(2x) and R(2x+1), where 15≧×≧8.

The 16 16-bit registers in bank 2 may be used to store 16-bit GPR (Rx) values or 16-bit quantities of 32-bit base address (Ax) values used during address operations. The 16 16-bit registers in bank 2 are arranged in pairs. One of each of the register pairs is labeled Rx/AxL in FIG. 4, and may be used to store either a 16-bit GPR (Rx) value or a least-significant or lower 16-bit quantity (AxL) of a 32-bit base address (Ax) value used during an address operation. The other register of the register pair is labeled Rx/AxH, and may be used to store another 16-bit GPR (Rx) value or a most-significant or higher 16-bit quantity (AxH) of the 32-bit base address (Ax) value. Each of the 8-bit guard registers Gx is associated with the corresponding pair of general purpose registers R(2x) and R(2x+1), where 23≧×≧16.

The registers in bank 3 are arranged like those in bank 2. The 16 16-bit registers in bank 3 may be used to store 16-bit GPR (Rx) values or 16-bit quantities of 32-bit base address (Ax) values used during address operations. The 16 16-bit registers in bank 3 are arranged in pairs. One of each of the register pairs is labeled Rx/AxL in FIG. 4, and may be used to store either a 16-bit GPR (Rx) value or a least-significant or lower 16-bit quantity (AxL) of a 32-bit base address (Ax) value used during an address operation. The other register of the register pair is labeled Rx/AxH, and may be used to store another 16-bit GPR (Rx) value or a most-significant or higher 16-bit quantity (AxH) of the 32-bit base address (Ax) value. Each of the 8-bit guard registers Gx is associated with the corresponding pair of general purpose registers R(2x) and R(2x+1), where 31≧×≧24.

In the unified register file 208 of FIG. 4, address register values and data register values (i.e., GPR values) are often mapped to the same multipurpose registers. More specifically, 16 16-bit index (Nx) values are mapped to the same 16 16-bit registers in bank 1 that may also be used to store 16-bit GPR (Rx) values, and 16 32-bit Ax values are mapped to the same 32 16-bit registers in banks 2 and 3 that may also be used to store 16-bit GPR (Rx) values. As described in more detail below, the multipurpose registers in the unified register file 208 are essentially allocated only when needed. As all unused multipurpose registers in the unified register file 208 remain available for use, the overall performance and utility of the processor core 104 of FIGS. 1 and 2 is improved over a processor core having separate register files for address values and data values.

In the embodiment of FIG. 4, each of the 8-bit guard registers Gx is used with the corresponding register pair {R(2x), R(2x+1)} to form a 40-bit accumulator in a multiply-accumulate (MAC) operation. An exemplary MAC instruction is of the form “mac Rz,Rx,Ry” wherein the specified MAC operation is {Gz:R(2z+1):R(2z)}={Gz:R(2z+1):R(2z)}+Rx·Ry, where Rz specifies the 40-bit accumulator {Gz:R(2z+1):R(2z)} formed by concatenating the 8-bit guard register Gz, the 16-bit register R(2z+1), and the 16-bit register R(2z). It is noted that z is an integer between 0 and 31, and x and y are integers between 0 and 63.

In the embodiment of FIG. 4, each of the 8-bit guard registers Gx can also be updated independently via a move instruction such as “mov Gx,Ry” wherein the least significant 8 bits of the 16-bit Ry register are stored in the 8-bit guard register Gx. Each of the 8-bit guard registers Gx can also be updated via bit manipulation instructions such as the bit set instruction “bits Gx,n,” the bit clear instruction “bitc Gx,n,” and the bit invert instruction “biti Gx,n,” wherein n specifies the affected bit position, and 7≧n≧0.

Referring back to FIGS. 2 and 3, address arithmetic instructions such as the “add Ax,Nx” instruction described above are performed in the LSU 204. During executions of such instructions, the Ax and Nx registers (i.e., the source address registers) in the unified register file 208 are read during the RD pipeline stage, and the address result is computed during the AG pipeline stage. The LSU 204 stores the address result in the Ax register in the unified register file 208 during the execution (EX) stage.

Load and store instructions that access values stored in the memory system 106 of FIG. 1, such as the load instruction “Id Rx,Ax,Nx” instruction described above, are also performed in the LSU 204. During executions of such instructions, the Ax and Nx registers (i.e., the source address registers) in the unified register file 208 are read during the RD pipeline stage, and the address result is computed during the AG pipeline stage. During the memory address 0 (M0) stage, the load/store unit 204 translates the address result to an external memory addresses used within the memory system 106 of FIG. 1. During the memory address 1 (M1) stage, the load/store unit 204 uses the external memory addresses to obtain the operand value from the memory system 106 of FIG. 1. During the execution (EX) stage, the LSU 204 stores the operand value in the Rx register in the unified register file 208.

Data arithmetic and multiply-accumulate (MAC) operations are carried out in the ALU 212 and the MAU 214, respectively. During executions of instructions specifying such operations, operands are obtained during the memory address 1 (M1) stage, and the specified operations are carried out during the execution (EX) stage.

Referring back to FIG. 4, the unified register file 208 also includes write address decoders 404 and write data multiplexers (muxes) 408 associated with the upper bank 402, and write address decoders 406 and write data muxes 410 for the lower bank 400. As indicated in FIG. 4, both the write address decoders 404 and the write address decoders 406 receive write signals from the 2 load/store units in the LSU 204, the 2 ALUs in the ALU 212, and/or the 2 MAUs in the MAU 214. The write address decoders 404 and the write data multiplexers (muxes) 408 are used to access the registers of banks 2 and 3 of the unified register file 208 during write operations, and the write address decoders 406 and the write data multiplexers (muxes) 410 are used to access registers of banks 0 and 1 of the unified register file 208 during write operations.

The unified register file 208 also includes read address decoders 412 associated with the upper bank 402, read address decoders 414 for the lower bank 400, and read data muxes 416. As indicated in FIG. 4, the read data muxes 415 communicates with the 2 load/store units in the LSU 204, the 2 ALUs in the ALU 212, and the 2 MAUs in the MAU 214. The read address decoders 412 are used to access the registers of banks 2 and 3 of the unified register file 208 during read operations, and the read address decoders 414 are used to access registers of banks 0 and 1 of the unified register file 208 during read operations. During read operations, the read data muxes 415 receive register information from the instruction issue logic 202 of FIG. 2, and provide register data specified by the register information to the 2 load/store units in the LSU 204, the 2 ALUs in the ALU 212, and/or the 2 MAUs in the MAU 214.

The unified register file 208 not only expectedly increases the number of available data registers, it also improves signal routing as all of the multiplexing between the upper bank 402 and the lower bank 400 is done locally within the unified register file 208. The destination buses 220 in FIG. 2 converge at one destination, and the signal routing is more controllable.

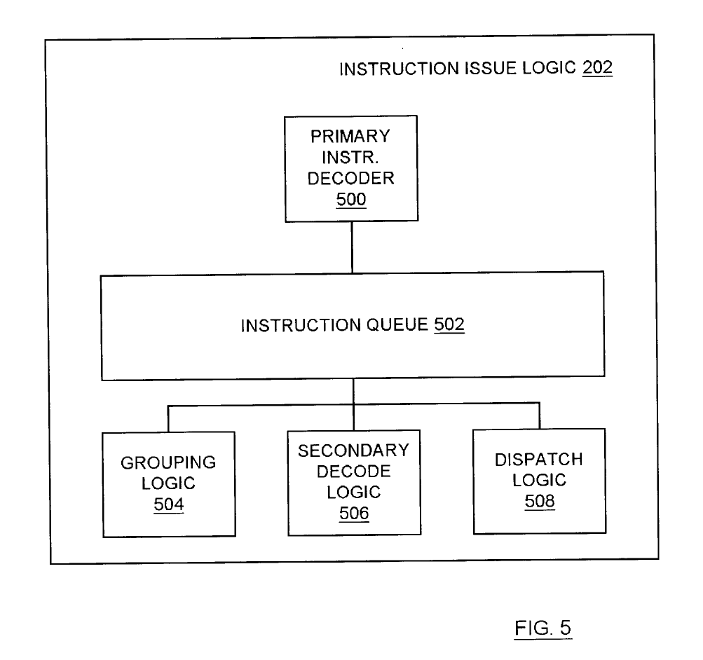

FIG. 5 is a diagram of one embodiment of the instruction issue logic 202 of FIG. 2. In the embodiment of FIG. 5, the instruction issue logic 202 includes a primary instruction decoder 500, an instruction queue 502, grouping logic 504, secondary decode logic 506, and dispatch logic 508.

In one embodiment, the primary instruction decoder 500 includes an n-slot queue (n>1) for storing partially decoded instruction received (or retrieved) from the instruction prefetch unit 200 of FIG. 2 (e.g., from an instruction queue of the instruction prefetch unit 200). Each of the n slots has dedicated decode logic associated with it. Up to n instructions occupying the n slots are fully decoded during the fetch/decode (FD) stage of the pipeline and stored in the instruction queue 504.

The primary instruction decoder 500 maps address and data values to registers in the unified register file 208 of FIG. 4. In the embodiment shown and described herein, when the primary instruction decoder 500 encounters an instruction reference to an index register Nx, where 15≧×≧0, the primary instruction decoder 500 appends a value ‘01,’ associated with bank 1 of the unified register file 208 of FIG. 4, as a prefix to a 4-bit value ‘xxxx’ uniquely identifying the index register Nx. The resulting 6-bit value ‘01xxxx’ uniquely identifies a 16-bit register in bank 1 of the unified register file 208 of FIG. 4.

When the primary instruction decoder 500 encounters an instruction reference to an address register Ax, where 7≧×≧0, the primary instruction decoder 500 appends a value ‘10,’ associated with bank 2 of the unified register file 208 of FIG. 4, as a prefix to a 4-bit value ‘xxxx’ uniquely identifying the address register Ax. The resulting 6-bit value ‘10xxxx’ uniquely identifies a pair of 16-bit registers in bank 2 of the unified register file 208 of FIG. 4.

When the primary instruction decoder 500 encounters an instruction reference to an address register Ax, where 15≧×≧8, the primary instruction decoder 500 appends a value ‘11,’ associated with bank 3 of the unified register file 208 of FIG. 4, as a prefix to a 4-bit value ‘xxxx’ uniquely identifying the address register Ax. The resulting 6-bit value ‘11xxxx’ uniquely identifies a pair of 16-bit registers in bank 3 of the unified register file 208 of FIG. 4.

For example, when the primary instruction decoder 500 encounters an add instruction “add A0,N0” which performs an address operation and produces an address result, the primary instruction decoder 500 recognizes the unique opcode of the add instruction indicating the add instruction is an address operation producing an address result. The primary instruction decoder 500 appends the value ‘10,’ associated with bank 2 of the unified register file 208 of FIG. 4, as a prefix to a 4-bit value ‘0000’ uniquely identifying the address register A0. The resulting 6-bit value ‘100000’ uniquely identifies the pair of 16-bit registers labeled R32/A0L and R33/A0H in the unified register file 208 of FIG. 4. Similarly, the primary instruction decoder 500 appends the value ‘01,’ associated with bank 1 of the unified register file 208 of FIG. 4, as a prefix to a 4-bit value ‘0000’ uniquely identifying the index register N0. The resulting 6-bit value ‘010000’ uniquely identifies the 16-bit register labeled R16/N0 in the unified register file 208 of FIG. 4.

It is noted that the add instruction “add A0,N0”, by virtue of its unique opcode, will be dispatched to the LSU 204 of FIG. 2. In contrast, the add instruction “add Rx,Rx” performs a data operation and produces a data result, has a different opcode, and is dispatched to the ALU 212 of FIG. 2.

It is also noted that other embodiments of the unified register file 208 of FIG. 4, and the primary instruction decoder 500 of FIG. 5, are possible and contemplated. For example, in other embodiments of the unified register file 208 of FIG. 4, address and data values may map to all of the registers of the unified register file 208 (i.e., all of the registers of the unified register file 208 may be multipurpose registers), and the primary instruction decoder 500 of FIG. 5 may be configured to perform the mapping function.

In the grouping (GR) stage of the pipeline, the instruction queue 502 provides fully decoded instructions (e.g., from the n-slot queue) to the grouping logic 504. The grouping logic 504 performs dependency checks on the fully decoded instructions by applying a predefined set of dependency rules (e.g., write-after-write, read-after-write, write-after-read, etc.). The set of dependency rules determine which instructions can be grouped together for simultaneous execution (e.g., execution in the same cycle of the CLOCK signal).

The instruction queue 502 is used to store fully decoded instructions (i.e., “instructions”) which are queued for grouping and dispatch to the pipeline. In one embodiment, the instruction queue 502 includes n slots and instruction ordering multiplexers. The number of instructions stored in the instruction queue 502 varies over time dependent upon the ability to group instructions. As instructions are grouped and dispatched from the instruction queue 502, newly decoded instructions received from the primary instruction decoder 500 may be stored in empty slots of the instruction queue 502.

The secondary decode logic 506 includes additional instruction decode logic used in the grouping (GR) stage, the operand read (RD) stage, the memory access 0 (M0) stage, and the memory access 1 (M1) stage of the pipeline. In general, the additional instruction decode logic provides additional information from the opcode of each instruction to the grouping logic 506. For example, the secondary decode logic 506 may be configured to find or decode a specific instruction or group of instructions to which a grouping rule can be applied.

In one embodiment, the dispatch logic 508 queues relevant information such as native opcodes, read control signals, or register addresses for use by the execution unit 206, unified register file 208, and load/store unit 204 at the appropriate pipeline stage.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What we claim as our invention is:

1. A processor, comprising:
a register file comprising a plurality of registers, wherein a portion of the registers are used to store both address register values and data register values.

2. The processor as recited in claim 1, wherein the address register values are address values used to perform address operations, and the data register values are data values used to perform data operations.

3. The processor as recited in claim 1, wherein an architecture of the processor specifies a plurality of address registers used to store the address register values, and the address registers are mapped to the portion of the registers of the register file.

4. The processor as recited in claim 1, wherein an architecture of the processor specifies a plurality of general purpose registers used to store the data register values, and the general purpose registers are mapped to the portion of the registers of the register file.

5. The processor as recited in claim 1, wherein a first portion of the registers are used to store both address register values and data register values, and a second portion of the registers are used to store both index register values and data register values.

6. The processor as recited in claim 5, wherein the address register values and the index register values are address values used to perform address operations, and the data register values are data values used to perform data operations.

7. The processor as recited in claim 5, wherein an architecture of the processor specifies a plurality of address registers used to store the address register values, and the address registers are mapped to the first portion of the registers of the register file.

8. The processor as recited in claim 5, wherein an architecture of the processor specifies a plurality of index registers used to store the index register values, and the index registers are mapped to the second portion of the registers of the register file.

9. The processor as recited in claim 5, wherein an architecture of the processor specifies a plurality of general purpose registers used to store the data register values, and the general purpose registers are mapped to the first and second portions of the registers of the register file.

10. A processor, comprising:
a register file comprising a plurality of registers; and
an instruction decoder configured to decode instructions, wherein each instruction includes an opcode and specifies a register, and wherein the instruction decoder is configured to map the register specified by the instruction to a corresponding register of the register file dependent upon the opcode.

11. The processor as recited in claim 10, wherein the register specified by the instruction contains a value, and the opcode specifies an operation to be performed using the value.

12. The processor as recited in claim 11, wherein the register specified by the instruction contains an address value, and the opcode specifies an address operation to be performed using the address value.

13. The processor as recited in claim 11, wherein the instructions include a first instruction specifying a register containing an address value and a second instruction specifying a register containing a data value, and wherein the instruction decoder maps the registers specified by the first and second instructions to the same register of the register file.

14. The processor as recited in claim 10, wherein an instruction includes a value identifying the register specified by the instruction, and wherein in the event the opcode specifies an address operation is to be performed, the instruction decoder is configured to append a bank value to the value identifying the register specified by the instruction, thereby forming a value uniquely identifying the corresponding register of the register file.

15. A processor, comprising:
a register file comprising a plurality of registers arranged to form a plurality of banks; and
an instruction decoder configured to decode instructions, wherein each instruction includes an opcode and specifies a register, wherein the instruction decoder is configured to map the register specified by the instruction to a register in a corresponding bank of the register file dependent upon the opcode.

16. The processor as recited in claim 15, wherein the register file includes 2ⁿ registers each uniquely identified by an n-bit value.

17. The processor as recited in claim 16, wherein the processor comprises 2ⁿ data registers each uniquely identified by a corresponding n-bit value, and wherein an instruction specifying one of the data registers includes the corresponding n-bit value identifying the data register, and wherein the instruction decoder does not change the n-bit value identifying the data register.

18. The processor as recited in claim 16, wherein the data registers are general purpose registers.

19. The processor as recited in claim 16, wherein the processor comprises 2^{m} address registers each uniquely identified by a corresponding m-bit value, wherein n>m, and wherein an instruction specifying one of the address registers includes the corresponding m-bit value identifying the address register, and wherein in the event the opcode specifies an address operation is to be performed, the instruction decoder is configured to append an (n-m)-bit bank value to the m-bit value identifying the address register specified by the instruction, thereby forming an n-bit value uniquely identifying a register in the corresponding bank of the register file.

20. The processor as recited in claim 16, wherein the processor comprises 2^{m} index registers each uniquely identified by a corresponding m-bit value, wherein n>m, and wherein an instruction specifying one of the index registers includes the corresponding m-bit value identifying the index register, and wherein in the event the opcode specifies an address operation is to be performed, the instruction decoder is configured to append an (n-m)-bit bank value to the m-bit value identifying the index register specified by the instruction, thereby forming an n-bit value uniquely identifying a register in the corresponding bank of the register file.

21. The processor as recited in claim 15, wherein each bank of the register file includes an equal number of registers.

22. A method for mapping a register specified by an instruction to a corresponding register of a register file, comprising:
if an opcode of the instruction specifies an address operation is to be performed, appending a bank value to a value in the instruction uniquely identifying the specified register, thereby forming a value uniquely identifying the corresponding register of the register file.

23. The method as recited in claim 22, wherein each register of the register file is uniquely identified by an n-bit value, and wherein the register specified by the instruction is uniquely identified by an m-bit value, and wherein n>m.

24. The method as recited in claim 23, wherein the bank value is an (n-m)-bit value.
